(19) United States
(12) Patent Application Publication
(10) Pub. No.: US 2016/0000121 A1
(43) Pub. Date: Jan. 7, 2016

(54) POWDER EMULSIFYING AGENT COMPOSITION AND METHOD FOR PRODUCING SAME

(71) Applicant: DAI-ICHI KOGYO SEIYAKU CO., LTD., Kyoto-shi, Kyoto (JP)

(72) Inventors: Haruki TAKATOYA, Kyoto (JP); Keisuke KUSUI, Kyoto (JP)

(73) Assignee: DAI-ICHI KOGYO SEIYAKU CO., LTD., Kyoto-shi, Kyoto (JP)

(21) Appl. No.: 14/769,036

(22) PCT Filed: Mar. 12, 2014
(86) PCT No.: PCT/JP2014/056409

§ 371 Date: Aug. 19, 2015

(30) Foreign Application Priority Data
Mar. 29, 2013 (JP) 2013-073428

(51) Int. Cl. A23L 1/035; A23L 1/217

(52) U.S. Cl. CPC A23L 1/035; A23L 1/217

(57) ABSTRACT

Provided are: a powder emulsifying agent composition which has improved dispersibility and is capable of providing food with excellent texture; and a production method by which this powder emulsifying agent composition can be obtained easily. An emulsifying agent composition that contains (A) a saccharide, (B) a glycerol fatty acid monoester and (C) a lecithin, in which the phospholipid content is 90% by mass or more and the total content of phosphatidic acid and a hydrogenated product thereof is 5-30% by mass, is used. This emulsifying agent composition is obtained by spray drying an aqueous dispersion that contains the components (A)-(C).

### TECHNICAL FIELD

The present invention relates to a powder emulsifying agent composition that is used mainly as a food additive for improving textures, and to a method for producing the composition.

### BACKGROUND ART

A glycerin fatty acid monoester has been widely used as a food additive for improving textures. However, the glycerin fatty acid monoester has a melting point of 67° C. and is difficult to be dissolved and mixed with food, and therefore the dispersibility thereof in use is desired to be improved.

As a method for improving the dispersibility, there is known a method of powdering an O/W emulsion that contains a glycerin fatty acid monoester. For example, discloses a technique of obtaining, according to the method, a powder frothing agent that contains a saturated monoglyceride, a saturated diglycerin monoester, a lecithin (soybean lecithin in Examples) and the like. However, the powder composition of PTL 1 is insufficient in dispersibility and the textures of the foods produced by using it are unsatisfactory.

PTL 2 discloses a food frothing agent that is an O/W emulsion containing a sugar alcohol, a lecithin, a sucrose fatty acid ester, a glycerin fatty acid monoester, and the like. This is characterized in that an emulsion having a specific particle size distribution is used as it is liquid, but the dispersibility thereof is still insufficient and the desired effect cannot be realized, and in addition, as being liquid, there is another problem in that it is inconvenient to handle.

In PTL 3, the present inventors disclosed a powder frothing agent containing a dextrin-containing saccharide, a glycerin fatty acid monoester and a surfactant and capable of keeping the α-crystal state of the monoglyceride for a long period of time, and proposed, as the production method for the agent, powdering by spray drying with a spray drier. Here, a lecithin is used as the surfactant in Examples, but this is a soybean lecithin, and the object of the invention differs from that of the present invention.

### CITATION LIST

### Patent Literature

### PTL 1: JP-A 4-325049

### PTL 2: JP-A 2007-82463

### PTL 3: JP-A 2011-142838

### SUMMARY OF INVENTION

### Technical Problem

The present invention has been made in consideration of the above, and its object is to provide a powder emulsifying agent composition having higher dispersibility and capable of providing foods with more improved textures, and to provide a production method by which the emulsifying agent composition can be obtained easily.

### Solution to Problem

For solving the above-mentioned problem, the powder emulsifying agent composition of the present invention contains (A) a saccharide, (B) a glycerin fatty acid monoester, and (C) a lecithin in which a phospholipid content is 90% by mass or more and a total content of a phosphatidic acid and a hydrogenated product thereof is from 5 to 30% by mass.

The powder emulsifying agent composition of the present invention preferably contains the component (A) in an amount of from 30 to 89% by mass, the component (B) in an amount of from 10 to 40% by mass, and the component (C) in an amount of from 1 to 30% by mass.

As the saccharide (A), for example, usable here is a polysaccharide.

The emulsifying agent composition of the present invention is preferably one obtained by spray-drying an aqueous dispersion containing the above-mentioned components (A), (B) and (C).

The production method for the powder emulsifying agent composition of the present invention is a method including a step of spray-drying the above-mentioned aqueous dispersion of the present invention that contains (A) a saccharide, (B) a glycerin fatty acid monoester and (C) a lecithin in which a phospholipid content is 90% by mass or more and a total content of a phosphatidic acid and a hydrogenated product thereof is from 5 to 30% by mass, by using a spray drier under a condition that a drying outlet temperature is 75° C. or lower.

### Advantageous Effects of Invention

The powder emulsifying agent composition of the present invention contains, as described above, a saccharide, a glycerin fatty acid monoester and a lecithin having specific components, and therefore has higher dispersibility as compared with already-existing emulsifying agents, and by using this, foods having more improved textures and appearance can be provided.

According to the production method for the powder emulsifying agent composition of the present invention, the above-mentioned emulsifying agent composition of the present invention can be obtained more efficiently and easily.

### DESCRIPTION OF EMBODIMENTS

### 1. (A) Saccharide

The saccharide (A) for use in the present invention is a component that is used for powdering the composition (for preparation formulation), and is not specifically limited so far as it meets the object. For this, monosaccharides, disaccharides, polysaccharides, sugar alcohols and the like are widely usable. Of these, one alone may be used singly or two or more may be used as combined. More concretely, as monosaccharides, there are mentioned glucose, fructose, galactose, etc. As disaccharides, there are mentioned sucrose, lactose, trehalose, maltose, etc. As polysaccharides, there are mentioned dextrin, reduced dextrin, indigestible dextrin, cyclodextrin, branched dextrin, starch, pectin, etc.; and as sugar alcohols, there are mentioned sorbitol, xylitol, maltitose, etc. The above-mentioned starch includes decomposed products thereof. Accordingly, starch includes wheat starch, potato starch, corn starch, tapioca starch, etc.; and starch decomposed products include hydrolyzed products of the above-mentioned starch. In addition, heat-moisture-treated starch is also usable here.

Of the above, preferred are polysaccharides and especially preferred is dextrin, as more excellent in spray driability.

The content of the saccharide is preferably from 30 to 89 parts by mass and more preferably from 40 to 85 parts by mass in 100 parts by mass of the powder emulsifying agent composition.

### 2. (B) Glycerin Fatty Acid Monoester

As glycerin that constitutes the glycerin fatty acid monoester (B) for use in the present invention, use can be made without specific limitations of any one obtainable from natural oils and fats such as beef tallow or cotton seed oil, or one to be obtained by distilling these, or synthetic products, etc.

As the fatty acid that constitutes the glycerin fatty acid monoester, any hitherto-known fatty acid may be used, but from the viewpoint of frothability, emulsion dispersibility, easiness in producing the powder emulsifying agent composition and others, the fatty acid is preferably a saturated or unsaturated fatty acid having from 12 to 22 carbon atoms, more preferably a saturated or unsaturated fatty acid having from 14 to 22 carbon atoms, and even more preferred is a saturated fatty acid.

The saturated fatty acid having from 12 to 22 carbon atoms includes, for example, lauric acid, myristic acid, palmitic acid, stearic acid, arachidic acid, behenic acid, etc. The unsaturated fatty acid having from 12 to 22 carbon atoms includes, for example, oleic acid, linolic acid, linolenic acid, erucic acid, etc.

The content of the glycerin fatty acid monoester is preferably from 10 to 40 parts by mass and more preferably from 20 to 35 parts by mass in 100 parts by mass of the powder emulsifying agent composition.

### 3. (C) Lecithin

“Lecithin” as referred to in the present invention indicates all aspects of phospholipid-containing lipid products, and contains various components depending on the starting material and the degree of purification.

The lecithin for use in the present invention has a phospholipid content of 90% by mass or more and preferably 95% by mass or more. In this, the total content of phosphatidic acid and a hydrogenated product thereof is from 5 to 30% by mass and preferably from 7 to 30% by mass. Incorporating the lecithin of the type in which the phospholipid and the total content of phosphatidic acid and a hydrogenated product thereof could fall within the above-mentioned range further improves the dispersibility of the emulsifying agent composition and further enhances the textures of foods. The lecithin of the type may be produced, for example, through fractionation such as high-level purification or solvent extraction of a pasty soybean lecithin generally distributed in the market. A pasty soybean lecithin generally distributed in the market has a phospholipid content of about 60% by mass and a total content of phosphatidic acid and a hydrogenated product thereof of from about 5 to 20% by mass.

The phospholipids that may be contained in the lecithin other than phosphatidic acid and a hydrogenated product thereof include phosphatidylcholine, phosphatidylethanolamine, phosphatidylinositol, lysophosphatidylcholine, etc. The content of these is not specifically limited, but preferably, phosphatidylcholine accounts for from 1 to 35% by mass, phosphatidylethanolamine accounts for from 10 to 30% by mass, phosphatidylinositol accounts for from 10 to 30% by mass, and lysophosphatidylcholine accounts for from 1 to 30% by mass.

The lecithin content is preferably from 1 to 30 parts by mass and more preferably from 2 to 20 parts by mass in 100 parts by mass of the powder emulsifying agent composition.

### 4. Other Components

The powder emulsifying agent composition of the present invention may contain any other component than the above-mentioned components (A) to (C). For example, the emulsifying agent composition of the present invention may contain a surfactant such as a sucrose fatty acid ester, a propylene glycol fatty acid ester, a sorbitan fatty acid ester, and any other glycerin fatty acid ester than the glycerin fatty acid monoester (B), within a range not contradictory to the object of the present invention.

In a case where a sucrose fatty acid ester is used, HLB thereof is preferably from 10 to 16. The constituting fatty acid is preferably a fatty acid having from 12 to 22 carbon atoms, for which there may be exemplified the ones hereinbefore exemplified for the glycerin fatty acid monoester (B). The sucrose fatty acid ester content is preferably from 5 to 30 parts by mass and more preferably from 10 to 20 parts by mass in 100 parts by mass of the powder emulsifying agent composition.

In a case where a propylene glycol fatty acid ester is used, the constituting fatty acid is preferably a fatty acid having from 12 to 22 carbon atoms, for which usable are the fatty acids hereinbefore exemplified for the glycerin fatty acid monoester (B). The propylene glycol fatty acid ester content is preferably from 0.2 to 15 parts by mass and more preferably from 0.5 to 10 parts by mass in 100 parts by mass of the powder emulsifying agent composition.

In a case where a sorbitan fatty acid ester is used, the constituting fatty acid is preferably a fatty acid having from 12 to 22 carbon atoms, for which there may be exemplified the ones hereinbefore exemplified for the glycerin fatty acid monoester (B). The sorbitan fatty acid ester content is preferably from 0.2 to 15 parts by mass and more preferably from 0.5 to 10 parts by mass in 100 parts by mass of the powder emulsifying agent composition.

Further, in a case where any other glycerin fatty acid ester than the glycerin fatty acid monoester (B) is used, the type of which is not specifically limited. As preferred examples, there are mentioned “glycerin fatty acid/organic acid monoesters” including esters of short-chain carboxylic acids or the like, and for example, they may contain a non-long-chain carboxylic acid such as citric acid, succinic acid, acetic acid, diacetyltartaric acid, or lactic acid. Also employable are polyglycerin fatty acid monoesters.

### 4. Production Method for Powder Frothing Agent

In the production method for the powder emulsifying agent composition of the present invention, first, the above-mentioned (A) a saccharide, (B) a glycerin fatty acid monoester, (C) a lecithin in which the phospholipid content is 90% by mass or more and the total content of phosphatidic acid and a hydrogenated product thereof is from 5 to 30% by mass, and water are mixed to prepare an aqueous dispersion (emulsion) of these.

Concretely, to 100 parts by mass of the total amount (solid content) of the component (A), the component (B) and the component (C) is added water preferably in an amount of from 100 parts by mass to 900 parts by mass, followed by stirring and mixing until a stable dispersion (emulsion) could be obtained. The stirring may be attained according to an ordinary stirring means of using a homomixer (Disper blade), etc.

Next, the aqueous dispersion prepared in the above is dried into powder. As the drying means, preferred is spray drying, and for example, favorably employed is a spray-drying method. The powder emulsifying agent composition of the present invention may be powdered through spray drying as above, and may therefore have higher dispersibility, and the effect thereof to improve food textures may be more remarkable.

The condition in drying according to a spray-drying method is preferably such that the exhaust gas temperature (drying outlet temperature) is 75° C. or lower and more preferably 70° C. Also preferably, it is 50° C. or higher and more preferably 60° C. or higher. Drying in the above-mentioned temperature range may improve the dispersibility of the emulsifying agent composition and may eventually improve more the textures and the appearance of foods.

### 5. Use of Powder Emulsifying Agent Composition

The powder emulsifying agent composition of the present invention may be widely used for the whole range of foods. In a case where the composition is used in baked confectionery including snack foods such as potato chips; and also in bread, cakes and others, its effect of improving the textures and the appearance of those foods is remarkably obtained.

The method of using the composition is not specifically limited. In a production process for the above-mentioned foods, the powder as it is may be suitably added to the ingredients and mixed with them. In a case where it is used in the above-mentioned baked confectionery and the like, it may be incorporated and mixed along with the other ingredients and additives in preparing the dough.

Not specifically limited, the amount to be used of the powder emulsifying agent composition of the present invention may be suitably determined depending on the object to which it is used and on the intended use thereof. In general, the amount may fall within a range of from 0.1 to 15 parts by mass relative to 100 parts by mass of the object to which it is used (the material ingredients than the water added) such as the dough ingredient.

### EXAMPLES

The present invention is described more concretely with reference to the following Examples. However, the present invention is not limited to the following Examples. Unless otherwise specifically indicated in the following, “part” means “part by mass” and “%” means “% by mass”.

### Examples 1 to 3, Comparative Examples 1 and 2

In the following Examples and Comparative Examples, used was a lecithin containing phosphatidic acid and other phospholipids in the ratio shown in Table 1 below.

TABLE 1

| | Content (mass%) | | | | |
|---|---|---|---|---|---|
| | Lecithin 1 | Lecithin 2 | Lecithin 3 | Lecithin 4 | Lecithin 5 |
| Total of Phospholipid | 96 | 97 | 98 | 60 | 98 |
| Phosphatidic Acid | 12 | 18 | 30 | 8 | 3 |
| Phosphatidylcholine | 30 | 28 | 5 | 19 | 6 |
| Phosphatidylethanolamine | 24 | 26 | 6 | 15 | 4 |
| Phosphatidylinositol | 17 | 16 | 15 | 11 | 16 |
| Lysophosphatidylcholine | 13 | 9 | 42 | 7 | 69 |

The materials shown in Table 2 were combined in the ratio (parts by mass) shown in the Table, and mixed by using a homomixer (Disper blade) at 70° C. to control an aqueous dispersion.

Subsequently, by using a spray drier (intake gas temperature 125° C., exhaust gas temperature 68° C.), the dispersion was spray-dried at a feed amount of 6 L/h to produce a powder emulsifying agent composition.

TABLE 2

| | Ex. 1 | Ex. 2 | Ex. 3 | Comp. Ex. 1 | Comp. Ex. 2 |
|---|---|---|---|---|---|
| Dextrin | 82 | 65 | 50 | 82 | 50 |
| Glycerin Fatty Acid | 15 | 25 | 35 | 15 | 35 |
| Monostearate | | | | | |
| Lecithin 1 | 3 | | | | |
| Lecithin 2 | | 10 | | | |
| Lecithin 3 | | | 15 | | |
| Lecithin 4 | | | | 3 | |
| Lecithin 5 | | | | | 15 |

### <Evaluation in Bread>

Two hundred and fifty parts of bread flour, 4 parts of salt, 25 parts of sugar, 5 parts of dry yeast, 25 parts of butter, 25 parts of eggs, the powder emulsifying agent in an amount of 2 parts as the total of the glycerin fatty acid monoester (B) and the lecithin (C), and 125 parts of milk were mixed at a low speed for 10 minutes by using a mixer, and then fermented at 33° C. for 20 minutes to control a dough. Subsequently, the dough was taken out in a vat, flattened by hand with degassing, and then folded up twice. This was divided into pieces each weighing 45 g, rounded softly so that the surface thereof could be tight, and then arranged on a sheet pan. Further, these were fermented at 33° C. for 30 minutes, and then baked in an oven at 200° C. as the upper fire and at 206° C. as the lower fire, for 11 minutes, and thereafter these were left at room temperature. The specific volume and the texture in 30 minutes after baking and the texture in 3 hours after the baking were evaluated according to the methods mentioned below. The results are shown in Table 3.

### <<Evaluation Method for Specific Volume>>

According to the following rapeseed method, the bread volume was measured, and then multiplied by the bread mass to determine the specific volume (ml/g).

Rapeseed Method: (1) Polystyrene beads are filled in a predetermined container, and the volume thereof is measured with a measuring cylinder. (2) Next, the baked bread is put into the container, and polystyrene beads are filled in the remaining space, and the volume of the thus-filled polystyrene beads is measured also with a measuring cylinder. The volume of the polystyrene beads filled in (2) is subtracted from the volume of the polystyrene beads alone in (1), to thereby determine the volume of the bread.

### <<Texture Evaluation Method>>

According to the following evaluation standards, evaluation by 10 monitors was conducted and the resultant scores were averaged.

5: Soft

4: Relatively soft

3: Not so soft

2: Relatively crusty

1: Crusty

TABLE 3

| | Ex. 1 | Ex. 2 | Ex. 3 | Comp. Ex. 1 | Comp. Ex. 2 |
|---|---|---|---|---|---|
| Specific Volume | 3.0 | 2.9 | 2.9 | 2.4 | 2.5 |
| (ml/g) | | | | | |
| Texture | 4.7 | 4.6 | 4.8 | 3.3 | 3.4 |
| (after 30 minutes) | | | | | |
| Texture | 4.2 | 4.3 | 4.3 | 2.3 | 2.4 |
| (after 3 hours) | | | | | |

### <Evaluation in Shaped Potato Chips>

Ninety parts of dry mashed potato, and the powder emulsifying agent in an amount of 0.3 parts as the total of the glycerin fatty acid monoester (B) and the lecithin (C) were mixed in powder, then 200 parts of hot water was added thereto and mixed for 1 minute to prepare a dough. The resultant dough was rolled into a thickness of 0.8 mm by using a roller, shaped into a disc, and then fried in rice oil at 180° C. for 45 seconds to give shaped potato chips. The appearance immediately after fried and the texture in 10 minutes after the frying were evaluated according to the methods mentioned below. The results are shown in Table 4.

### <<Appearance Evaluation Method>>

According to the following evaluation standards, evaluation by 10 monitors was conducted and the resultant scores were averaged.

5: Smooth with no roughness

4: Not so much roughened

3: Relatively roughened

2: Materially roughened

1: Extremely roughened

### <<Texture Evaluation Method>>

According to the following evaluation standards, evaluation by 10 monitors was conducted and the resultant scores were averaged.

5: Extremely crispy

4: Materially crispy

3: Relatively crispy

2: Not so much crispy

1: Not crispy at all

TABLE 4

| | Ex. 1 | Ex. 2 | Ex. 3 | Comp. Ex. 1 | Comp. Ex. 2 |
|---|---|---|---|---|---|
| Appearance | 4.9 | 4.8 | 4.7 | 2.7 | 2.7 |
| Texture | 4.8 | 4.7 | 4.7 | 2.6 | 2.7 |

### INDUSTRIAL APPLICABILITY

The powder emulsifying agent composition of the present invention is especially favorably used in snack foods such as potato chips, as well as in baked confectionery, bread, cakes, etc.

1. A powder emulsifying agent composition, comprising
(A) a saccharide,
(B) a glycerin fatty acid monoester, and
(C) a lecithin in which a phospholipid content is 90% by mass or more and a total content of a phosphatidic acid and a hydrogenated product thereof is from 5 to 30% by mass.

2. The powder emulsifying agent composition according to claim 1, comprising the component (A) in an amount of from 30 to 89% by mass, the component (B) in an amount of from 10 to 40% by mass, and the component (C) in an amount of from 1 to 30% by mass.

3. The powder emulsifying agent composition according to claim 1, wherein the saccharide (A) is a polysaccharide.

4. The powder emulsifying agent composition according to claim 1, obtained by spray-drying an aqueous dispersion containing the component (A), the component (B) and the component (C).

5. A production method for the powder emulsifying agent composition described in claim 1, comprising a step of spray-drying an aqueous dispersion comprising (A) a saccharide, (B) a glycerin fatty acid monoester and (C) a lecithin wherein a phospholipid content is 90% by mass or more and a total content of a phosphatidic acid and a hydrogenated product thereof is from 5 to 30% by mass, by using a spray drier under a condition that a drying outlet temperature is 75° C. or lower.
